(19) United States
(12) Patent Application Publication
(10) Pub. No.: US 2017/0037280 A1
(43) Pub. Date: Feb. 9, 2017

(54) ANTISTATIC ADHESIVE COMPOSITION AND POLARIZING PLATE MANUFACTURED USING SAME

(71) Applicant: DONGWOO FINE-CHEM CO., LTD., Jeollabuk-do (KR)

(72) Inventor: Han Young CHOI, Jeollabuk-do (KR)

(21) Appl. No.: 15/332,337

(22) Filed: Oct. 24, 2016

Related U.S. Application Data
(63) Continuation of application No. PCT/KR2015/003172, filed on Mar. 31, 2015.

(30) Foreign Application Priority Data
Apr. 30, 2014 (KR) 10-2014-0052592

(51) Int. Cl. C09J 7/00; C09J 11/04; C09J 11/06; B32B 27/08; G02B 1/14; G02B 1/16; G02B 5/30; B32B 7/12; C09J 133/06; C09J 11/08

(52) U.S. Cl. CPC C09J 7/00; C09J 133/066; C09J 11/04; C09J 11/06; C09J 11/08; G02B 1/14; G02B 1/16; G02B 5/305; B32B 7/12; B32B 27/08; C09J 2433/00; B32B 2307/42

(57) ABSTRACT

An antistatic adhesive composition includes a polyalkyleneglycol compound having one or more carboxyl group or thiol group in a molecule, an acryl copolymer, a cross-linking agent, and an antistatic agent. The antistatic composition exhibits excellent antistatic property, as well as significantly improving adhesiveness, thus to exhibit superior durability even at a high temperature. A polarizing plate fabricated using the antistatic composition is also provided.

### CROSS REFERENCE TO RELATED APPLICATIONS AND CLAIM OF PRIORITY

The present application is a continuation application to International Application No. PCT/KR2015/003172, with an International Filing Date of Mar. 31, 2015, which claims the benefit of Korean Patent Application No. 10-2014-0052592, filed on Apr. 30, 2014, at the Korean Intellectual Property Office, the disclosures of which are incorporated by reference herein in their entirety.

### BACKGROUND

1. Technical Field

The present invention relates to an antistatic adhesive composition, and more particularly, to an antistatic adhesive composition with excellent antistatic property and durability, and a polarizing plate fabricated using the same.

2. Description of the Related Art

A liquid crystal display device includes liquid crystal cells containing liquid crystals and a polarizing plate, and the liquid crystal cells and the polarizing plate are normally bonded to each other by an adhesive layer formed on one surface of the polarizing plate. Other than the above components, in order to improve performance of the liquid crystal display device, surface protective films such as a phase retardation plate, a wide viewing angle compensation plate, a luminance-enhancing film, or the like may be additionally attached to the polarizing plate by an adhesive. Since optical members such as the surface protective film and the polarizing plate are formed of plastic materials, static electricity can be generated during rubbing or peeling-off the surface protective film. When voltage is applied to the liquid crystals in the presence of residual static electricity, orientation of the liquid crystal molecules may be damaged or defects may occur in a liquid crystal panel. Therefore, in order to prevent such problems, various antistatic treatments are performed.

For example, there is a method of obtaining antistatic characteristics by adding an antistatic agent including polyether polyol and an alkaline metal salt to an acryl adhesive. However, this method causes bleeding of the antistatic agent to hence considerably reduce durability after curing the adhesive. If this method is applied to the protective film, bleed-out easily occurs under high temperature conditions to cause a pollution of a subject to be adhered.

Further, there is a method for achieving an antistatic property by adding at least one surfactant to an adhesive and transferring the surfactant to a subject to be adhered. However, this method also has a problem of easily bleeding the surfactant on the surface of the adhesive. When this method is applied to a protective film, it may also cause the pollution of the subject to be adhered.

Korean Patent Laid-Open Publication No. 2010-0093470 discloses an adhesive composition comprising an alkyleneglycol dialkylether compound with improved antistatic property in addition to proper optical characteristics, as an additive having high interaction with ions. Korean Patent Laid-Open Publication No. 2012-0132396 discloses an adhesive composition with desired antistatic property and durability, which includes a polyether compound having a reactive silyl group at at least one end thereof. However, the above compositions do not have exhibit sufficient compatibility of the antistatic agent, and thus a reduction of durability caused by bleeding-out of the antistatic agent may not be sufficiently prevented.

### SUMMARY

Accordingly, it is an aspect of the present invention to provide an adhesive composition capable of significantly improving adhesiveness and enhancing durability while maintaining desired or improved antistatic property.

The above aspect of the present invention will be achieved by the following characteristics:

(1) An adhesive composition, including: a polyalkyleneglycol compound having one or more carboxyl group or thiol group in a molecule; an acryl copolymer; a cross-linking agent; and an antistatic agent.

(2) The adhesive composition according to the above (1), wherein the polyalkyleneglycol compound is selected from a group consisting of compounds represented by Formulae 1 to 4 below:

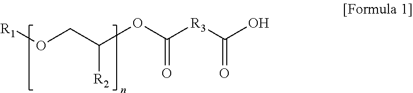

(wherein, in formula 1, R₁ is a hydrogen atom, an alkyl group having 1 to 20 carbon atoms, a cycloalkyl group having 3 to 20 carbon atoms or an aryl group having 6 to 12 carbon atoms,

R₂ is a hydrogen atom or a methyl group,

R₃ is an alkylene group having 2 to 3 carbon atoms, an alkenylene group having 2 to 4 carbon atoms, or an arylene group having 6 to 12 carbon atoms, and n is an integer of 1 to 100)

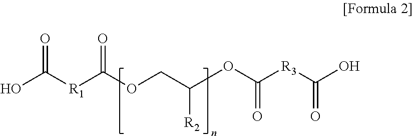

(wherein, in Formula 2, R₁ and R₃ are each independently an alkylene group having 2 to 3 carbon atoms, an alkenylene group having 2 to 4 carbon atoms, or an arylene group having 6 to 12 carbon atoms,

R₂ is a hydrogen atom or a methyl group, and n is an integer of 1 to 100)

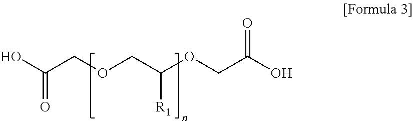

(wherein, in Formula 3, R₁ is a hydrogen atom or a methyl group, and n is an integer of 1 to 100).

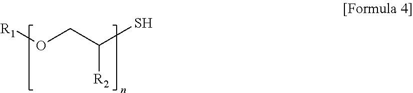

(wherein, in Formula 4, R₁ is a hydrogen atom, an alkyl group having 1 to 20 carbon atoms, a cycloalkyl group having 3 to 20 carbon atoms or an aryl group having 6 to 12 carbon atoms, and the alkyl group, cycloalkyl group or aryl group may be further substituted by a thiol group,

R₂ is a hydrogen atom or a methyl group, and n is an integer of 1 to 100).

(3) The adhesive composition according to the above (2), wherein the compounds represented by Formulae 1 and 2 is at least one selected from a group consisting of compounds represented by Formulae 5 and 6 below:

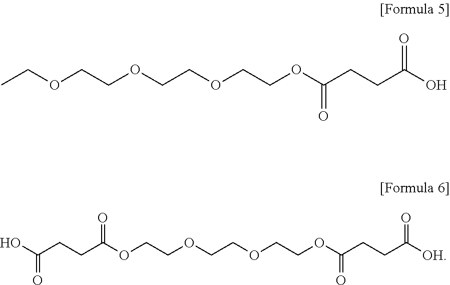 [SMILES: CCOCCOCCOCCOC(=O)CCC(=O)O ; O=C(O)CCC(=O)OCCOCCOCCOC(=O)CCC(=O)O]

(4) The adhesive composition according to the above (2), wherein the compound represented by Formula 3 is polyethyleneglycol bis(carboxymethyl) ether having a weight average molecular weight ranging from 100 to 1,000.

(5) The adhesive composition according to the above (2), wherein the compound represented by Formula 4 is any one selected from a group consisting of polyethyleneglycol methyletherthiol having a weight average molecular weight ranging from 500 to 1,200, polyethyleneglycol dithiol having a weight average molecular weight ranging from 500 to 1,500, and a mixture thereof.

(6) The adhesive composition according to the above (1), wherein the polyalkyleneglycol compound having one or more carboxyl group or thiol group in a molecule is included in an amount of 0.1 to 10 parts by weight relative to 100 parts by weight of the acryl copolymer based on solid content.

(7) The adhesive composition according to the above (1), wherein the antistatic agent is at least one of bis(fluorosulfonyl)imide potassium (KN(FSO₂)₂) or bis(fluorosulfonyl)imide sodium (NaN(FSO₂)₂).

(8) An adhesive sheet including an adhesive layer formed of the adhesive composition according to the above (1) to (7).

(9) A polarizing plate including an adhesive layer formed of the adhesive composition according to the above (1) to (7) on at least one surface thereof.

(10) The polarizing plate according to the above (9), further including a polarizer and a protective film adhered to at least one surface of the polarizer, wherein the adhesive layer is formed on the protective film.

(11) The polarizing plate according to the above (10), wherein the protective film is a cellulose film.

(12) An image display device including the polarizing plate according to the above (9).

The polyalkylene glycol compound having one or more carboxyl group or thiol group in a molecule according to the embodiments of the present invention may form a hydrogen bond or a covalent bond with glass to improve adhesiveness, so that durability may be significantly improved, when compared to a case in which a conventional polyalkylene glycol compound is used as an additive.

In addition, by effectively coordinating cations of the antistatic agent with a non-covalent electron pair of adjacent oxygen of a polyalkylene glycol moiety, a degree of dissociation between ions of the antistatic agent may be increased to improve the antistatic property, as well as, by fixing the antistatic agent, bleed-out may be prevented, thereby remarkably improving durability of the adhesive composition.

### DETAILED DESCRIPTION

Embodiments of the present invention provides an antistatic adhesive composition including: an acryl copolymer; a cross-linking agent; an antistatic agent; and a polyalkylene (e.g., 2 to 3 of carbon atoms) glycol compound having one or more carboxyl group or thiol group in a molecule, thereby maintaining excellent antistatic property, as well as exhibiting significantly improved durability even under severe conditions of a high temperature, thus to exhibit significantly improved adhesiveness, and a polarizing plate fabricated using the same.

Hereinafter, exemplary embodiments of the present invention will be described in detail.

<Adhesive Composition>

The adhesive composition according to embodiments of the present invention includes an acryl copolymer; a cross-linking agent; an antistatic agent, and a polyalkylene (e.g., 2 to 3 of carbon atoms) glycol compound having one or more carboxyl group or thiol group in a molecule.

The polyalkyleneglycol compound according to embodiments of the present invention has one or more carboxyl group or thiol group in a molecule, and may attain more excellent antistatic property, adhesiveness and durability than the conventional adhesive composition.

In example embodiments, since the polyalkyleneglycol compound has the above-described structure, the compound may form a hydrogen bond or a covalent bond with glass to significantly improve adhesiveness, such that durability may be also significantly improved, compared to a conventional unsubstituted polyalkylene glycol.

In addition, by effectively coordinating cations of the antistatic agent with a non-covalent electron pair of adjacent oxygen of a polyalkylene glycol moiety in a molecule, a degree of dissociation between ions of the antistatic agent may be increased, and the adhesive composition according to embodiments of the present invention may exhibit excellent antistatic property. Further, the polyalkyleneglycol compound according to embodiments of the present invention may fix the antistatic agent so that bleed-out may be prevented, thereby remarkably improving durability of the adhesive composition.

The polyalkyleneglycol compound according to the present invention may include any compound so long as it has one or more carboxyl group or thiol group in a molecule. Preferably, the polyalkyleneglycol compound having one or more carboxyl group or thiol group in a molecule may be represented by Formulae 1 to 4 below:

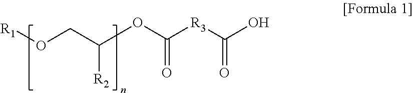

In Formula 1, R₁ may be a hydrogen atom, an alkyl group having 1 to 20 carbon atoms, a cycloalkyl group having 3 to 20 carbon atoms or an aryl group having 6 to 12 carbon atoms. R₂ may be a hydrogen atom or a methyl group. R₃ may be an alkylene group having 2 to 3 carbon atoms, an alkenylene group having 2 to 4 carbon atoms, or an arylene group having 6 to 12 carbon atoms, and n may be an integer of 1 to 100.

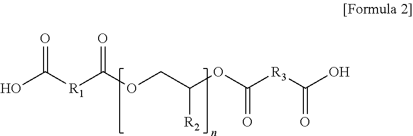

In Formula 2, R₁ and R₃ may be each independently an alkylene group having 2 to 3 carbon atoms, an alkenylene group having 2 to 4 carbon atoms, or an arylene group having 6 to 12 carbon atom. R₂ may be a hydrogen atom or a methyl group, and n may be an integer of 1 to 100.

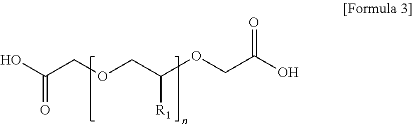

In Formula 3, R₁ may be a hydrogen atom or a methyl group, and n may be an integer of 1 to 100.

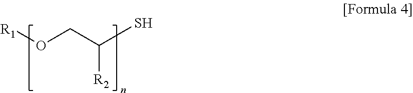

In Formula 4, R₁ may be a hydrogen atom, an alkyl group having 1 to 20 carbon atoms, a cycloalkyl group having 3 to 20 carbon atoms or an aryl group having 6 to 12 carbon atoms, and the alkyl group, cycloalkyl group or aryl group may be further substituted by a thiol group. R₂ may be a hydrogen atom or a methyl group, and n may be an integer of 1 to 100.

Examples of the compounds represented by Formulae 1 and 2 may be compounds represented by Formulae 5 and 6 below, respectively. These compounds may be used alone or in combination of two or more thereof.

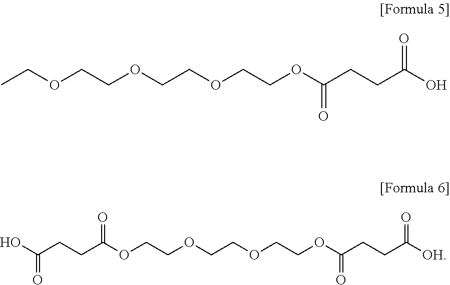 [SMILES: CCOCCOCCOCCOC(=O)CCC(=O)O ; O=C(O)CCC(=O)OCCOCCOCCOC(=O)CCC(=O)O]

Examples of the compound represented by Formula 3 may be polyethyleneglycol bis(carboxymethyl) ether which may have a weight average molecular weight ranging from 100 to 1,000.

Examples of the compound represented by Formula 4 may be polyethyleneglycol methyletherthiol which have a weight average molecular weight ranging from 500 to 1,200, or polyethyleneglycol dithiol which have a weight average molecular weight ranging from 500 to 1,500. These compounds may be used alone or in combination of two or more thereof.

A content of the polyalkyleneglycol compound having one or more carboxyl group or thiol group in a molecule according to embodiments of the present invention may not be particularly limited but may be included, for example, in an amount of 0.1 to 10 wt. parts relative to 100 wt. parts of acryl copolymer based on solid content. If the content thereof is less than about 0.1 wt. part, improvement of antistatic effects and durability may not be sufficient, and if the content thereof exceeds about 10 wt. part, durability may be reduced due to bleed-out of the polyalkyleneglycol compound having one or more carboxyl group or thiol group in a molecule.

The acryl copolymer may include any one known in the related art without particular limitation thereof.

For example, the acryl copolymer may include a compound polymerized while including (meth)acrylate monomer having an alkyl group with 1 to 12 carbon atoms and a polymerizable monomer having a cross-linkable functional group. Herein, (meth)acrylate can mean both of acrylate and methacrylate.

The (meth)acrylate monomer having an alkyl group with 1 to 12 carbon atoms may include, for example, n-butyl(meth)acrylate, 2-butyl(meth)acrylate, t-butyl(meth)acrylate, 2-ethylhexyl(meth)acrylate, ethyl(meth)acrylate, methyl(meth)acrylate, n-propyl(meth)acrylate, isopropyl(meth)acrylate, pentyl(meth)acrylate, n-octyl(meth)acrylate, isooctyl(meth)acrylate, nonyl(meth)acrylate, decyl(meth)acrylate, lauryl(meth)acrylate, or the like. Among these, n-butylacrylate, 2-ethylhexylacrylate or a mixture thereof is preferably used. These compound may be used alone or in combination of two or more thereof.

A content and mixing ratio of the (meth)acrylate monomer having an alkyl group with 1 to 12 carbon atoms are not particularly limited but may be included, for example, in an amount of 85 to 99.9 wt. parts, and preferably, 90 to 95 wt. parts relative to 100 wt. parts of whole monomers based on solid content. If the content thereof is less than about 85 wt. parts, desired adhesiveness cannot be sufficiently realized, and if the content thereof exceeds about 99.9 wt. parts, cohesiveness may be reduced.

The polymerizable monomer having a cross-linkable functional group may be a component for reinforcing cohesiveness or adhesive strength of the adhesive composition through a chemical bond to thus provide durability and cutting ability. For example, the polymerizable monomer may include a monomer having a carboxyl group, a monomer having a hydroxyl group, a monomer having an amide group, a monomer having a tertiary amine group, or the like. These may be used alone or in combination of two or more thereof. From an aspect of improvement in anti-corrosive property, it may be preferable not to include acrylic acid.

The monomer having a carboxyl group may include, for example, mono-valent acids such as (meth)acrylic acid, crotonic acid, etc.; di-valent acids such as maleic acid, itaconic acid, fumaric acid, etc., and monoalkylesters thereof; 3-(meth)acryloylpropionic acid; a ring-opening adduct of succinic anhydride of 2-hydroxyalkyl (meth)acrylate having an alkyl group with 2 and 3 carbon atoms, a ring-opening adduct of succinic anhydride of hydroxylalkyleneglycol (meth)acrylate having an alkylene group with 2 to 4 carbon atoms, a compound prepared by ring-opening addition of succinic anhydride to a caprolactone adduct of 2-hydroxyalkyl (meth)acrylate having an alkyl group with 2 or 3 carbon atoms, or the like. Among these, (meth)acrylic acid may be preferably used.

The monomer having a hydroxyl group may include, for example, 2-hydroxyethyl (meth)acrylate, 2-hydroxypropyl (meth)acrylate, 2-hydroxybutyl (meth)acrylate, 4-hydroxybutyl (meth)acrylate, 6-hydroxylhexyl (meth)acrylate, 2-hydroxyethyleneglycol (meth)acrylate, 2-hydroxylpropyleneglycol (meth)acrylate, hydroxylalkyleneglycol (meth)acrylate having an alkylene group with 2 to 4 carbon atoms, 4-hydroxybutylvinylether, 5-hydroxypentylvinylether, 6-hydroxyhexylvinylether, 7-hydroxyheptylvinylether, 8-hydroxyoctylvinylether, 9-hydroxynonylvinylether, 10-hydroxydecylvinylether, or the like. Among these, 4-hydroxybutylvinylether may be preferably used.

The monomer having an amide group may include, for example, (meth)acrylamide, N-isopropyl acrylamide, N-tert-butyl acrylamide, 3-hydroxypropyl (meth)acrylamide, 4-hydroxybutyl (meth)acrylamide, 6-hydroxyhexyl (meth)acrylamide, 8-hydroxyoctyl (meth)acrylamide, 2-hydroxyethylhexyl (meth)acrylamide, or the like. Among these, (meth)acrylamide may be preferably used.

The monomer having a tertiary amine group may include, for example, N,N-(dimethylamino)ethyl (meth)acrylate, N,N-(diethylamino)ethyl (meth)acrylate, N,N-(dimethylamino)propyl (meth)acrylate, or the like.

The monomer having a cross-linkable functional group may be included in an amount of 0.1 to 15 wt. parts, and preferably, 0.5 to 8 wt. parts relative to 100 wt. parts of whole monomers based on solid content. If the content thereof is less than about 0.1 wt. part, the adhesive composition may have decreased cohesiveness to reduce durability. If the content thereof exceeds about 15 wt. parts, adhesiveness may be decreased due to a high gel fraction to cause reduction in durability.

In addition to the above monomers, the acryl copolymer may further include a polymerizable monomer known in the related art within a range without causing deterioration in adhesiveness, for example, in a content of 10 wt. % or less relative to a total weight of whole monomers.

Methods for preparation of a copolymer are not particularly limited but the copolymer may be prepared by any conventional polymerization method such as bulk polymerization, solution polymerization, emulsion polymerization or suspension polymerization. Solution polymerization is preferably used. Further, solvents, polymerization initiators, chain transfer agents for controlling a molecular weight, or the like, generally used in the polymerization, may also be included.

The acryl copolymer may have a weight average molecular weight (in terms of polystyrene, Mw) measured by gel permeation chromatography (GPC) of 50,000 to 2,000,000, and preferably, 400,000 to 2,000,000. If the molecular weight is less than about 50,000, cohesiveness between copolymers may be insufficient to degrade adhesive durability. If the molecular weight exceeds about 2,000,000, a great amount of diluted solvent may be required in order to ensure desired workability during a coating process.

The cross-linking agent used in embodiments of the present invention may be a component for properly cross-linking the copolymer in order to reinforce cohesiveness of the adhesive composition, and may include, for example, an isocyanate-based cross-linking agent, an epoxy-based cross-linking agent, or the like, which may be used alone or in combination of two or more thereof.

The isocyanate-based cross-linking agent may include, for example: diisocyanate compounds such as tolylene diisocyanate, xylene diisocyanate, 2,4-diphenymethane diisocyanate, 4,4-diphenylmethane diisocyanate, hexamethylene diisocyanate, isophorone diisocyanate, tetramethylene xylene diisocyanate, naphthalene diisocyanate, etc.; adducts of polyalcohol compounds such as diisocyanate and trimethylolpropane diisocyanate, etc.; self-condensed isocyanurates of diisocyanate; burette body obtained by condensing diisocyanate on diisocyanate urea; polyfunctional isocyanate compounds having three functional groups such as triphenylmethane triisocyanate, methylenebistriisocyanate, etc., or the like.

The epoxy-based cross-linking agent may include, for example, ethyleneglycol diglycidylether, diethyleneglycol diglycidylether, polyethyleneglycol diglycidylether, propyleneglycol diglycidylether, tripropyleneglycol diglycidylether, polypropyleneglycol diglycidylether, neopentylglycol diglydicylether, 1,6-hexanediol diglycidylether, polytetramethyleneglycol diglycidylether, glycerol diglycidylether, glycerol triglycidylether, diglycerol polyglycidylether, polyglycerol polyglycideylether, resorcine diglycidylether, 2,2-dibromoneopentylglycol diglycidylether, trimethylolpropane glycidylether, pentaerythritol polyglycidylether, sorbitol polyglycidylether, adipic acid glycidylester, phthalic acid glycidylester, tris(glycidyl)isocyanurate, tris(glycidoxyethyl)isocyanurate, 1,3-bis(N,N-glycidylaminomethyl)cyclohexane, N,N,N′,N′-tetraglycidyl-m-xylyldiamine, or the like.

Further, at least one cross-linking agent selected from a group consisting of melamine derivatives, for example, hexamethylol melamine, hexamethoxymethyl melamine, hexabutoxymethyl melamine, or the like, may be further added to the above isocyanate-based cross-linking agent and the epoxy-based cross-linking agent.

An example of the commercially available cross-linking agent may include COR-HXR (Nippon Polyurethane Industry Co., Ltd.).

A content of the cross-linking agent is not particularly limited so long as it can fully express functions thereof but may include, for example, in a range of 0.1 to 15 wt. parts, and preferably, 0.1 to 5 wt. parts relative to 100 wt. parts of the acryl copolymer based on solid content. If the content thereof is less than about 0.1 wt. parts, cohesiveness decreases due to lack of cross-linking degree, and may deteriorate physical properties such as adhesive durability and cutting ability. If the content thereof exceeds about 15 wt. parts, a problem in mitigating residual stress may be caused due to excess cross-linking reaction.

The antistatic agent is not particularly limited so long as it is any one commonly used in the related art. For example, cations may include organic cations such as ammonium pyridinium, imidazolium, phosphonium, sulfonium, etc., or alkaline metal cations may be used, which are used alone or in combination of two or more thereof.

Examples of the ammonium may include a quaternary ammonium salt having four substituted alkyl groups such as tetrabutylammonium. Examples of pyridinium may include pyridinium having an alkyl group substituted at N of pyridine such as 1-ethyl pyridinium, 1-butyl pyridinium, 1-hexyl pyridinium, 1-butyl-3-methyl pyridinium, 1-butyl-4-methyl pyridinium, 1-hexyl-3-methyl pyridinium, 1-butyl-3,4-dimethyl pyridinium, 1-octyl-4-methyl pyridinium, etc. Examples of imidazolium may include imidazolium having an alkyl group substituted at 1,3-position of imidazole such as 1-methyl-3-butyl imidazolium, 1-methyl-3-hexyl imidazolium, etc. Examples of phosphonium may include quaternary phosphonium salt having four alkyl substituents such as tetrabutyl phosphonium. Examples of sulfonium may include tertiary sulfonium salt having three alkyl substituents such as tributyl sulfonium. Examples of alkaline metal cations may include lithium salts, sodium salts or potassium salts.

Anions used herein may include, for example, trifluoromethane sulfonate (OTf), toluene-4-sulfonate (OTs), methane sulfonate (OMs), Cl⁻, Br⁻, I₋, AlCl₄⁻, Al₂Cl₇⁻, BF₄⁻, PF6⁻, ClO₄⁻, NO₃⁻, CH3COO⁻, CF₃COO⁻, CH₃SO₃⁻, CF₃SO₃⁻ (CF₃SO₂)₂N⁻, (CF₃SO₂)₃C⁻, AsF₆—, SbF₆—, NbF₆—, TaF₆—, F(HF)n-, (CN)₂N—, C₄F₉SO₃⁻, (C₂F₅SO₂)₂N—, C₃F₇COO— or (CF₃SO₂)(CF₃CO)N⁻, or the like.

Among these, in consideration of durability and antistatic property, the sulfonylimide compound may be preferably used and may include, for example, compounds represented by Formula 7 below. In Formula 7, sulfonylimide anion may include fluorine atoms having high electronegativity to thus exhibit great stabilization effects of the anion present in a nitrogen atom, thereby achieving some advantages such as improvement in hydrophobic property of the antistatic agent to attain enhanced compatibility with acryl copolymer, no surface migration, durability reliability, and antistatic property. Therefore, the above compound may be preferably used.

M⁺[(SO₂R)₂N]⁻ [Formula 7]

In Formula 7, M may be an alkaline metal, and R may be a fluorine atom or perfluoroalkyl group having 1 to 4 carbon atoms.

The above alkaline metal may be lithium, sodium, potassium or cesium, and may be preferably, lithium, sodium or potassium.

Examples of the antistatic agent represented by Formula 7 may include, bis(fluorosulfonyl)imide potassium (KN(FSO₂)₂), bis(fluorosulfonyl)imide sodium (NaN(FSO₂)₂), bis(fluorosulfonyl)imide lithium (LiN(FSO₂)₂), bis(trifluorosulfonyl)imide potassium (KN(CF₃SO₂)₂), bis(trifluorosulfonyl)imide sodium (NaN(CF₃SO₂)₂) or bis(trifluorosulfonyl)imide lithium (LiN(CF₃SO₂)₂), or the like, and preferably, bis(fluorosulfonyl)imide potassium (KN(FSO₂)₂), bis(fluorosulfonyl)imide sodium (NaN(FSO₂)₂), which are used alone or in combination of two or more thereof.

The antistatic agent may be included in a content of 0.1 to 10 wt. parts, and preferably, 0.5 to 5 wt. parts relative to 100 wt. parts of acryl copolymer, based on solid content.

If the content thereof is less than about 0.1 wt. part, antistatic property may not be sufficiently obtained, and if the content thereof exceeds about 10 wt. parts, bleed-out may easily occur to cause poor exfoliation under heat resistant conditions.

The adhesive composition according to embodiments of the present invention may further include a silane coupling agent. The silane coupling agent may form a covalent bond with a polar group on the surface of a subject to be adhered to improve adhesiveness.

The silane coupling agent is not particularly limited if it contains a functional group such as amino, epoxy, acetoacetyl, polyalkyleneglycol, acryl or alkyl group. For example, the silane coupling agent may include vinyl trimethoxysilane, vinyl triethoxysilane, vinyltris(2-methoxyethoxy)silane, N-(2-aminoethyl)-3-aminopropylmethyldimethoxysilane, N-(2-aminoethyl)-3-aminopropyltrimethoxysilane, 3-aminopropyltriethoxysilane, 3-glycidoxypropyltrimethoxysilane, 3-glycidoxypropylmethyldimethoxysilane, 2-(3,4-epoxycyclohexyl)ethyltrimethoxysilane, 3-chloropropylmethoxyldimethoxysilane, 3-chloropropyltrimethoxysilane, 3-methacryloxypropyltrimethoxysilane, 3-mercaptopropyltrimethoxysilane, 3-glycidoxypropyltriethoxysilane, 3-glycidoxypropyldimethoxymethylsilane, 3-glycidoxypropylethoxydimethylsilane, or the like, which may be used alone or in combination of two or more thereof.

A content of the silane coupling agent is not particularly limited but may be included, for example, in an amount of 0.1 to 2 wt. parts, and preferably, 0.1 to 0.5 wt. part relative to 100 wt. parts of acryl copolymer, based on solid content. If the content thereof is less than about 0.1 wt. part, adhesion to a substrate may not be sufficient to cause exfoliation under heat and moist resistant conditions. If the content thereof exceeds about 2 wt. parts, cohesiveness may be excessively increased to degrade adhesive properties such as adhesiveness, and thus to cause reduction in durability.

The adhesive composition according to embodiments of the present invention may further include different additives generally used in the related art, e.g., an antioxidant, a corrosion-resistant agent, a defoaming agent, a filler, an antistatic agent, or the like, within a range not departing from the spirit of the present invention.

<Adhesive Sheet>

Further, the present invention provides an adhesive sheet including an adhesive layer formed of the adhesive composition.

A thickness of the adhesive layer is not particularly limited but may range, for example, from 3 to 100 μm, and preferably, 10 to 100 μm.

The adhesive sheet according to embodiments of the present invention may include an adhesive layer formed on at least one surface of a release film.

The adhesive layer may be formed by coating the at least one surface of the release film with the adhesive composition. A coating method is not particularly limited but may include any conventional method known in the related art. For example, bar coater, air knife, gravure, reverse roll, kiss roll, spray, blade, die coater, casting, spin coating, or the like may be employed.

The release film is not particularly limited but may include any conventional release film used in the related art. For example, the release film may include polyester resin such as polyethylene terephthalate, polybutylene terephthalate, polyethylene naphthalate, polybutylene naphthalate, etc.; polyimide resin; acryl resin; styrene resin such as polystyrene and acrylonitrile-styrene; polycarbonate resin; polylactic acid resin; polyurethane resin; polyolefin resin such as polyethylene, polypropylene, ethylene-propylene copolymer; vinyl resin such as polyvinyl chloride, polyvinylidene chloride, etc.; polyamide resin; sulfone resin; polyether-ether ketone resin; allylate resin; or a mixture thereof.

A thickness of the release film is not particularly limited but may range, for example, from 5 to 500 μm, and preferably, 10 to 100 μm.

<Polarizing Plate>

Further, the present invention provides a polarizing plate including an adhesive layer formed of the adhesive composition on at least one surface thereof.

The polarizing plate according to embodiments of the present invention may include a polarizer, a protective film adhered to at least one surface of the polarizer, and an adhesive layer formed of the adhesive composition on the protective film.

The polarizer may be any polarizer known in the related art, and for example, prepared by a process such as swelling, dying, cross-linking, drawing, washing, drying a polyvinyl alcohol film, or the like.

The protective film used herein may be any film so long as it has excellent properties such as transparency, mechanical strength, thermal stability, moisture-shielding properties, isotropic properties, or the like. For example, polyester films such as polyethylene terephthalate, polyethylene isophthalate, polybutylene terephthalate, etc.; cellulose films such as diacetylocellulose, triacetylcellulose, etc.; polycarbonate films; acryl films such as polymethyl (meth)acrylate, polyethyl (meth)acrylate, etc.; styrene films such as polystyrene, acrylonitrile-styrene copolymer, etc.; polyolefin films; vinyl chloride films; polyamide films such as nylon, aromatic polyamide, etc.; imide films; sulfone films; polyetherketone films; polyphenylene sulfide films; vinyl alcohol films; vinylidene chloride films; vinyl butyral films; allylate films; polyoxymethylene films; urethane films; epoxy films; silicon films, or the like, may be used. Among these, the cellulose film having a surface saponified using alkali or the like may be preferably used in consideration of polarizing properties or durability. The protective film may also serve as an optical layer.

The adhesive layer may be directly applied to the protective film, or formed by attaching an adhesive sheet to the protective film.

<Image Display Device>

Further, the present invention provides an image display device including the above-described polarizing plate.

The image display device according to embodiments of the present invention may further include elements and constructions well known in the related art in addition to the above polarizing plate.

Hereinafter, preferred embodiments are proposed to more concretely describe the present invention. However, the following examples are only given for illustrating the present invention and those skilled in the related art will obviously understand that these examples do not restrict the appended claims but various alterations and modifications are possible within the scope and spirit of the present invention. Such alterations and modifications are duly included in the appended claims.

### Preparation Example 1

### Preparation of Acryl Copolymer

A monomer mixture including 90 wt. parts of n-butyl acrylate, 7 wt. parts of methacrylate, 2 wt. parts of 2-hydroxyethyl acrylate and 1 wt. parts of acrylic acid was introduced into 1 L reactor equipped with a cooling device for easy control of temperature, in which a nitrogen gas is refluxed. Then, a solvent of 100 wt. parts of ethyl acetate (EAc) was added thereto. Next, after purging the nitrogen gas for 1 hour in order to remove oxygen, the mixture was maintained at 62° C. After homogenizing the mixture, 0.07 wt. parts of azobisisobutyronitrile (AIBN) as a reaction initiator was introduced into the reactor, followed by a reaction for 8 hours to prepare an acryl copolymer having a weight average molecular weight of about 1,000,000.

### Example

### (1) Preparation of Adhesive Composition

Adhesive compositions having constitutional compositions and contents listed in Table 1 below were prepared.

### (2) Formation of Adhesive Sheet

After preparing each of the adhesive compositions, it was applied to a film coated with a silicon release agent, followed by drying at 100° C. for 1 minute to form an adhesive layer having a thickness of 25 μm.

Then, the release film was laminated on the above adhesive layer, to prepare an adhesive sheet.

### (3) Fabrication of Adhesive-Adhered Polarizing Plate

After peeling-off the release film from the produced adhesive sheet, the adhesive layer was laminated on an iodine-based polarizing plate provided with a TAC protective film having a thickness of 185 μm, to obtain a polarizing plate including the adhesive layer adhered thereto.

TABLE 1

| | Poly- | | | Cross- | Silane | |
|---|---|---|---|---|---|---|
| | alkyleneglycol | | Acryl | linking | coupling | Antistatic |
| Section | compound | | copolymer | agent | agent | agent |
| (wt. part) | (A) | | (B) | (C) | (D) | (E) |
| Example 1 | A-1 | 2 | 100 | 1.0 | 0.5 | 1.0 |
| Example 2 | A-2 | 2 | 100 | 1.0 | 0.5 | 1.0 |
| Example 3 | A-3 | 2 | 100 | 1.0 | 0.5 | 1.0 |
| Example 4 | A-4 | 3 | 100 | 1.0 | 0.5 | 1.0 |
| Example 5 | A-5 | 3.5 | 100 | 1.0 | 0.5 | 1.0 |
| Example 6 | A-2 | 5.5 | 100 | 1.0 | 0.5 | 1.0 |
| Example 7 | A-2 | 11 | 100 | 1.0 | 0.5 | 1.0 |
| Comparative | — | — | 100 | 1.0 | 0.5 | 1.0 |
| Example 1 | | | | | | |
| Comparative | A-6 | 2 | 100 | 1.0 | 0.5 | 1.0 |
| Example 2 | | | | | | |
| Comparative | A-7 | 2 | 100 | 1.0 | 0.5 | 1.0 |
| Example 3 | | | | | | |

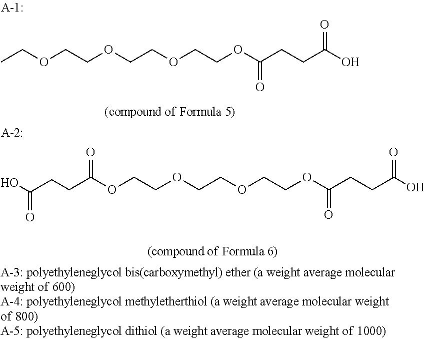 [SMILES: CCOCCOCCOCCOC(=O)CCC(=O)O ; O=C(O)CCC(=O)OCCOCCOCCOC(=O)CCC(=O)O]

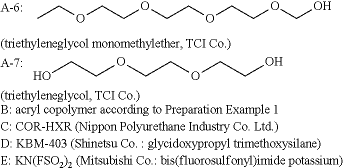

### Experimental Example

Each of the adhesive compositions prepared in the examples and comparative examples was applied to the release film coated with a silicon releasing agent to reach a thickness after curing of 25 μm, then, dried at 100° C. for 1 minute to form an adhesive layer.

Thereafter, the formed adhesive layer was laminated on an iodine polarizing film having triacetyl cellulose protective films adhered at both sides thereof (total thickness of 185 μm) by an adhering process to thus fabricate a polarizing plate. The fabricated polarizing plate was stored at 23° C. under a condition of 60% RH for 7 days.

### (1) Evaluation of Antistatic Property

A surface specific resistance of the fabricated polarizing plate was measured (unit: Ω·cm)

### (2) Evaluation of Adhesiveness

The release film of the polarizing plate including the adhesive layer adhered thereto was peeled-off, and a surface of the adhesive layer and an aluminum plate were adhered to each other, then autofclave treatment was executed by a pressure of 5 kg/cm² (490.3 kPa) at 50° C. for 20 minutes. Thereafter, a laminate specimen was prepared by leaving the same under atmosphere of 25° C. and 50 RH % for 24 hours.

Adhesiveness was measured by peeling off the polarizing plate from the laminate specimen at a speed of 300 mm/minute in a direction of 180° (unit: N/25 mm).

### (3) Evaluation of Heat Resistance

After removing the release film from the fabricated polarizing plate, the plate was adhered to a corning glass, followed by autoclave treatment. Then, after leaving the product at 60° C. for 300 hours, an occurrence of bubbles of exfoliation was observed and evaluated. Evaluation was performed after heat treating and then leaving the product at room temperature for 24 hours just before evaluating.

<Standards for Evaluation>

⊚: any bubble or exfoliation was not visually confirmed

◯: 1 or 2 bubbles or exfoliations were observed

Δ: 3 to 10 bubbles or exfoliations were observed

x: many bubbling and exfoliation (greater than 10) were observed

TABLE 2

| | Antistatic | | Heat |
|---|---|---|---|
| Section | property | Adhesiveness | resistance |
| Example 1 | 5 × 10¹⁰ | 8.7 | ⊚ |
| Example 2 | 6 × 10¹⁰ | 10.3 | ⊚ |
| Example 3 | 3 × 10¹⁰ | 7.5 | ⊚ |
| Example 4 | 4 × 10¹⁰ | 6.2 | ⊚ |
| Example 5 | 5 × 10¹⁰ | 7.1 | ⊚ |
| Example 6 | 4 × 10¹⁰ | 8.3 | ⊚ |
| Example 7 | 3 × 10¹⁰ | 6.1 | ◯ |
| Comparative | 1 × 10¹¹ | 4.1 | X |
| Example 1 | | | |
| Comparative | 4 × 10¹⁰ | 2.8 | Δ |
| Example 2 | | | |
| Comparative | 4 × 10¹⁰ | 3.8 | Δ |
| Example 3 | | | |

As seen from Table 2, it could be confirmed that the adhesive composition using the polyalkyleneglycol compound having one or more carboxyl group or thiol group in a molecule exhibited excellent antistatic property and improved adhesiveness, as well as high heat resistance to thus not easily induce exfoliation even under high temperature condition.

However, it could be seen that Example 7 including an excess of polyalkyleneglycol compound according to embodiments of the present invention demonstrated a slightly reduced heat resistance.

Meanwhile, it could be seen that the comparative examples demonstrated insignificant effects of improving antistatic property and significantly decreased heat resistance as a whole. In particular, it could be seen that Comparative Examples 2 and 3 exhibited enhanced antistatic property compared to Comparative Example 1 which did not include an additive corresponding to a polyalkyleneglycol compound, but lower adhesiveness and heat resistance than Examples.

What is claimed is:

1. An adhesive composition, comprising:
a polyalkyleneglycol compound having at one of a carboxyl group or a thiol group in a molecule;
an acryl copolymer;
a cross-linking agent; and
an antistatic agent.

2. The adhesive composition according to claim 1, wherein the polyalkyleneglycol compound is selected from the group consisting of compounds represented by Formulae 1 to 4: 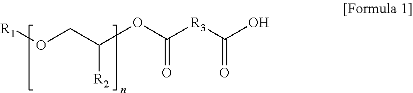
wherein, in Formula 1, R₁ is a hydrogen atom, an alkyl group having 1 to 20 carbon atoms, a cycloalkyl group having 3 to 20 carbon atoms or an aryl group having 6 to 12 carbon atoms;
R₂ is a hydrogen atom or a methyl group;
R₃ is an alkylene group having 2 to 3 carbon atoms, an alkenylene group having 2 to 4 carbon atoms, or an arylene group having 6 to 12 carbon atoms; and
n is an integer of 1 to 100; 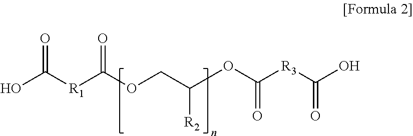
wherein, in Formula 2, R₁ and R₃ are each independently an alkylene group having 2 to 3 carbon atoms, an alkenylene group having 2 to 4 carbon atoms, or an arylene group having 6 to 12 carbon atoms;
R₂ is a hydrogen atom or a methyl group; and
n is an integer of 1 to 100; 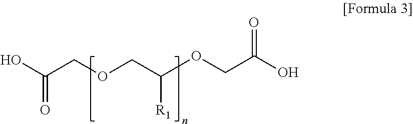
wherein, in Formula 3, R₁ is a hydrogen atom or a methyl group; and
n is an integer of 1 to 100′ 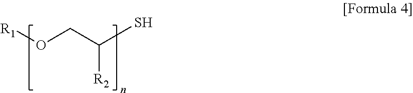
wherein, in Formula 4, R₁ is a hydrogen atom, an alkyl group having 1 to 20 carbon atoms, a cycloalkyl group having 3 to 20 carbon atoms or an aryl group having 6 to 12 carbon atoms, and the alkyl group, cycloalkyl group or aryl group are optionally further substituted by a thiol group;
R₂ is a hydrogen atom or a methyl group; and
n is an integer of 1 to 100.

3. The adhesive composition according to claim 2, wherein the polyalkyleneglycol compound is represented by Formula 1 or Formula 2, and the compounds represented by Formulae 1 and 2 are at least one selected from a group consisting of compounds represented by Formulae 5 and 6:

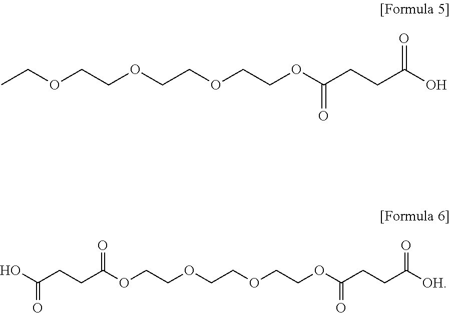 [SMILES: CCOCCOCCOCCOC(=O)CCC(=O)O ; O=C(O)CCC(=O)OCCOCCOCCOC(=O)CCC(=O)O]

4. The adhesive composition according to claim 2, wherein the polyalkyleneglycol compound is polyethyleneglycol bis(carboxymethyl) ether having a weight average molecular weight ranging from 100 to 1,000.

5. The adhesive composition according to claim 2, wherein the polyalkyleneglycol compound is any one selected from the group consisting of polyethyleneglycol methyletherthiol having a weight average molecular weight ranging from 500 to 1,200, polyethyleneglycol dithiol having a weight average molecular weight ranging from 500 to 1,500, and a mixture thereof.

6. The adhesive composition according to claim 1, wherein the polyalkyleneglycol compound is included in an amount of 0.1 to 10 parts by weight relative to 100 parts by weight of the acryl copolymer based on solid content.

7. The adhesive composition according to claim 1, wherein the antistatic agent is at least one of bis(fluorosulfonyl)imide potassium (KN(FSO₂)₂) or bis(fluorosulfonyl)imide sodium (NaN(FSO₂)₂).

8. An adhesive sheet comprising an adhesive layer formed of the adhesive composition according to claim 1.

9. A polarizing plate comprising an adhesive layer formed of the adhesive composition according to claim 1 on at least one surface thereof.

10. The polarizing plate according to claim 9, further comprising a polarizer and a protective film adhered to at least one surface of the polarizer, wherein the adhesive layer is formed on the protective film.

11. The polarizing plate according to claim 10, wherein the protective film is a cellulose film.

12. An image display device comprising the polarizing plate according to claim 9.
